(19) United States
(12) Patent Application Publication
(10) Pub. No.: US 2026/0329902 A1
(43) Pub. Date: Oct. 22, 2026

(54) DYNAMIC CONTEXTUAL EMBEDDING FOR INTELLIGENT QUERY ROUTING

(71) Applicant: Dell Products L.P., Round Rock, TX (US)

(72) Inventors: Zijia Wang, London (GB); Mustafa Al-Bado, Cork (IE); Thuy Truong, Co. Cork (IE)

(21) Appl. No.: 19/184,198

(22) Filed: Apr. 21, 2025

(51) Int. Cl. G06F 16/3329; G06F 16/334

(52) U.S. Cl. CPC G06F 16/33295; G06F 16/334

(57) ABSTRACT

Dynamic contextual embedding for query routing is disclosed. Contextual embeddings are generated using a query and historical examples as few shot trainings. The contextualized embeddings are used to generate a response. The response is refined and presented to a user.

### TECHNOLOGICAL FIELD OF THE DISCLOSURE

Embodiments disclosed herein generally relate to artificial intelligence/machine learning systems and methods for query routing. More particularly, at least some embodiments relate to systems, hardware, software, computer-readable media, and methods for contextual embedding and response refinement for intelligent query routing.

### BACKGROUND

In customer support environments, providing accurate and contextually relevant responses is an important aspect of maintaining high levels of customer satisfaction. Traditional customer support systems often struggle with understanding and adapting to the diverse range of customer inquiries, which leads to inefficiencies in ticket categorization and response generation. These systems typically rely on static models that lack flexibility in handling new and varied scenarios, which results in suboptimal customer interactions and increased operational costs.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of an artificial intelligence/machine learning system configured to generate contextually enriched embeddings and to refine automated responses;

FIG. 1B discloses aspects of a method for generating contextually enriched embeddings and refined automated responses;

FIG. 2A discloses aspects of an application that includes a contextual embedding generation module and an adaptive response module;

FIG. 2B discloses aspects of an architecture for generating contextual embeddings;

FIG. 3 discloses aspects of an iterative response refinement operation with feedback integration;

FIG. 4 discloses aspects of deploying and scaling systems configured to generate contextually enriched embeddings and refined responses; and

FIG. 5 discloses aspects of a computing device, a computing system, or a computing entity.

### DETAILED DESCRIPTION OF SOME EXAMPLE EMBODIMENTS

Embodiments disclosed herein generally relate to artificial intelligence/machine learning applications (AI/ML). More particularly, at least some embodiments relate to systems, hardware, software, computer-readable media, and methods for generating dynamic and contextualized embeddings and responses and to refining responses generated by AI/ML applications.

Embodiments of the invention are discussed in the context of AI/ML applications such as, but not limited to, customer service applications. Embodiments of the invention may be implemented in query/answer applications, chatbot applications, customer service applications, general knowledge applications, and the like or combinations thereof. Embodiments of the invention improve the accuracy, relevance, and efficiency of customer support applications. By delivering more personalized and effective responses, customer satisfaction is enhanced and support costs are reduced.

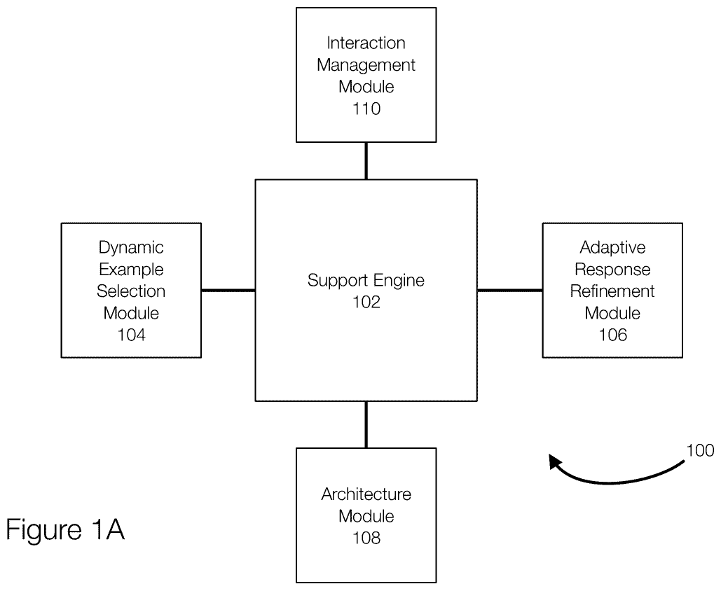

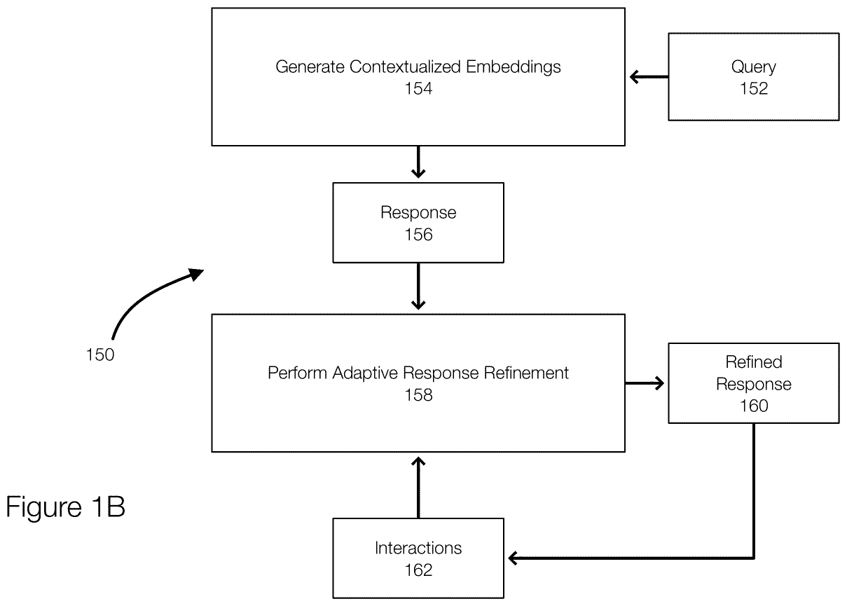

FIG. 1A discloses aspects of systems and methods for providing and/or enhancing an application such as a customer service system or application. FIG. 1A illustrates a customer service application 100 (or system) that may be cloud-based, edge-based, on-premise, distributed, or combinations thereof. The application 100 includes a support engine 102.

The application 100 is configured to improve/enhance customer support (or other application) using contextual embeddings that are generated dynamically and by refining responses. This enables the application 100 to dynamically adapt to varied customer queries. More specifically, in one example, a dynamic selection module 104 is configured to analyze incoming queries received at the support system 102, in real time, select relevant historical examples, and generate contextually enriched embeddings. In one example, few-shot learning is incorporated into the process of generating contextual embeddings. This allows the embeddings to be generated in a manner that benefits from historical examples.

The contextually enriched embeddings improve automated response generation and ticket categorization. The dynamic example selection model 104 is supported by an adaptive response refinement module 106. The module 106 iteratively enhances responses based on real-time feedback, such as user interactions. The system 100 may also include an architecture module 108, which is configured to integrate and deploy the application 100 into new and existing platforms.

More specifically, for example, the module 104, rather than generating responses based on static training data, selects relevant historical examples based on an analysis of the query in real-time. The selected historical examples may be used to generate enriched contextual embeddings, which are then used in generating a response to a user's query. The module 104 helps generate contextual embeddings are highly tailored to a specific query. The historical examples may be used as few-shot training examples.

The module 106 continually improves automated responses through real-time interactions and other feedback, ensuring improved performance over time. Unlike existing models that produce a one-time response, the application 100 (or support system 102) incorporates an iterative refinement process. More specifically, the module 106 continuously adjusts responses based on real-time customer interactions and other feedback, enabling the system 100 to evolve and improve its performance over time. Conventional models, in contrast, lack the capability of iterative enhancement.

Embodiments of the invention merge the generation of contextual embeddings with real-time dynamic selection of historical examples and an iterative refinement process to improve and enhance applications such as, for example, automated customer support applications. The application 100 is more accurate, context-aware, and continually improving responses.

For example, Q={q₁, q₂, . . . , qₙ} is an example of a set of customer queries. Each qᵢ belongs to a high-dimensional space Rd representing an embedding of the query. In one example, embodiments of the invention map each query qᵢ∈Q to a response rₜ∈R, where R={r₁, r₂, . . . , rₙ} is a set of responses. The mapping is denoted by a function ƒ: [symbol] ^{d}→ [symbol] ^{m}, where m is a dimensionality of the response space. This can be expressed as rᵢ=ƒ(qᵢ, H(qᵢ)).

In this example, H(qᵢ) is a function that dynamically selects historical examples from a database D={d₁, d₂, . . . , dₖ} based on the relevance of the historical examples to the query qᵢ. The function ƒ may also incorporate a feedback loop to iteratively refine r; based on customer interactions.

Embodiments of the invention provide a mechanism to dynamically select the most relevant historical examples, in real-time, and use the selected historical examples to generate embeddings that are contextually accurate and relevant. Embodiments of the invention iteratively refine response, based on real-time feedback from users, which also improves the accuracy and relevance of the response over time. Embodiments of the invention further provide scalability and efficiency while incorporating few-shot learning and adaptive mechanisms.

FIG. 1B discloses aspects of an example method for generating contextually relevant embeddings and iteratively refining responses. In FIG. 1B, the method 150 includes generating 154 contextualized embeddings based on a query 152. This may include using the query 152 to identify relevant historical examples from a database of examples. This historical examples selected from this database, along with the query 152, may be input to a machine learning model (e.g., a large language model (LLM)) configured to generate the contextualized embeddings based on the selected historical examples and the query. The contextualized embeddings may be input to the model (the same or different LLM) to generate a response 156.

Adaptive response refinement 158 may be performed 158 on the response 156 to generate a refined response 160. The refined response 160 may be returned to the user.

A user may interact with the refined response 160. Based on the interactions 162 (or other feedback), adaptive response refinement can be continually performed 158 on the response 156. When the interaction 162 includes a follow up query, the refined response 160 benefits from this type of interaction.

The method 150 is not limiting. For example, feedback generated from a particular interaction (e.g., interaction t) may be used to refine the response of the next interaction (e.g., interaction (t+1)).

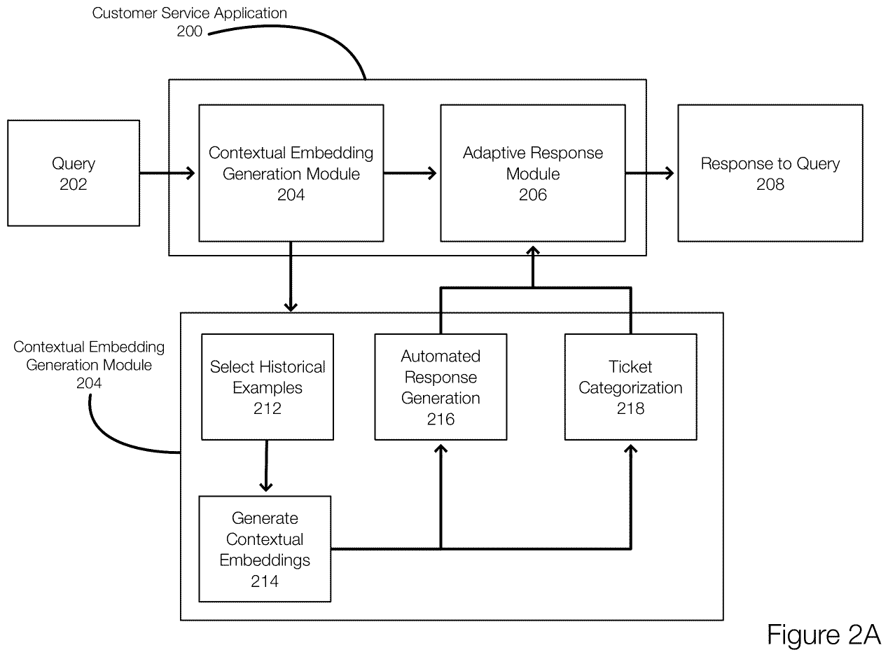

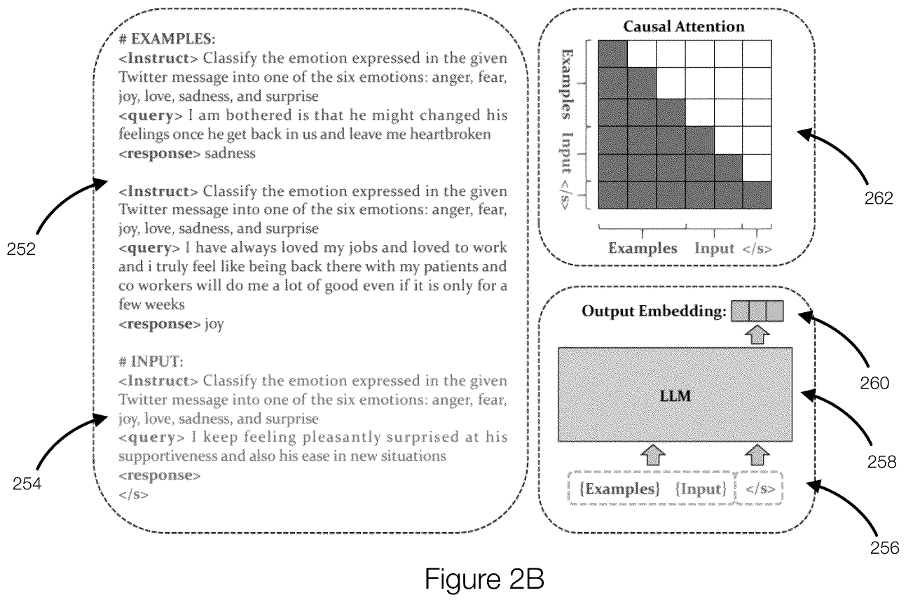

FIG. 2A discloses aspects of systems and methods of a customer support application and more particularly of a contextual embedding generation module and an adaptive response refinement module. In one example, the application 200 may include servers (processors, memory) and may be implemented as an edge-based system, a cloud-based system, an on-premise system, or the like. Further, the application 200 may be a distributed applications.

In the example of FIG. 2A, a query 202 may be received from a customer at a customer service application 200. The query 202 is received, more specifically, into a contextual embedding generation module 204 (module 204). The module 204 is configured to generate embeddings that capture a contextual meaning of the query 202 using, for example, few-shot learning, which may be based on a few historical examples.

The module 204 includes a selection module configured to ensure that the embeddings generated by the module 204 are relevant to a context of each query, such as the query 202. The module 204 may include or have access to large language models (LLMs).

In one example, the module 204 generates embeddings that capture contextual meanings of queries such as the query 152. The module 204 may leverage the in context learning capabilities of large language models and few-shot learning with dynamic historical example selection to enhance the relevance and adaptability of the embeddings being generated.

In this example, historical samples are selected 212 by a selection module. For example and as previously described, a set of customer queries may be represented as Q={q₁, q₂, . . . , qₙ}. Each qᵢ in this example is embedded into a high-dimensional vector space [symbol] ^{d}. In one example, embodiments of the invention map each query qᵢ to an embedding hᵢ∈ [symbol] ^{d} that captures or encapsulates both the semantic meaning and the contextual information relevant to the task or query.

In One Example, the Mapping is Achieved Using a Function ƒ_{θ} that is Parameterized by θ and Trained Using Few-Shot Learning Techniques as Follows:

hᵢ=ƒ_{θ}(qᵢ,Eᵢ).

In this example, Eᵢ represents a set of historical examples dynamically selected based on a current query qᵢ. The few-shot learning process is driven by a contrastive loss function defined as:

$$ℒ = - log \frac{exp ( s ( {h}_{i} , {h}^{+} )}{exp ( s ( {h}_{i} , {h}^{+} ) + {\sum }_{j} exp ( s ( {h}_{i} , {h}^{-} )} .$$

In this example, exp(s(hᵢ, h⁺) denotes a similarity score between the query embedding h; and the positive example embedding h⁺. In this example,

$${h}_{j}^{-}$$

represents a set of negative examples. The positive examples is the selected answer while the negative examples are the samples besides the positive examples in one embodiments.

Thus, historical samples are selected 212 based on their similarity to the query 202. The similarity may be similarity in the vector space. An embedding of the query may be compared to embeddings of the historical examples and the most similar may be the historical examples that are closest (in terms of distance, or cosine similarity). Thus, historical examples are selected 212. The historical examples along with the query are used to generate 214 the contextual embeddings.

FIG. 2B discloses aspects of generating contextualized embeddings. As illustrated in FIG. 2B, historical samples or examples are selected from a dataset of examples. The query 254 is combined with the historical examples 254 to formulate a prompt 256 to a large language model 258. The model 258 may generate contextualized embeddings 260 based on the prompt 256. In one example, causal attention 262 may be employed when generating the contextualized embeddings 260. Stated different, the model 258 may include causal attention mechanisms that impact the contextualized embeddings 260 generated by the model 258.

Returning to FIG. 2A, in one example, a response may be generated automatically 216 (e.g., by the model 258 or another LLM using the contextualized embeddings 260 as input. If the response cannot be generated, the response may be categorized 218 and a ticket may be generated.

Embodiments of the invention ensure that the embeddings are contextually relevant, in one example, by combining embeddings generation with dynamic example selection. The module 204 may integrate task-specific examples (e.g., historical examples) directly into the prompt 256, which includes the query 202. This allows a large language model to leverage an internal attention mechanism 262 to focus on both the query and the examples to generate more relevant contextualized embeddings.

When selecting 212 the historical examples, the query 202 may be analyzed in real time such that the most relevant (e.g., closest in distance) examples may be selected from a database D={d₁, d₂, . . . , dₖ}. The selected examples E; & D are the examples that maximize the contextual alignment with the query qᵢ, which is defined as:

$${E}_{i} = arg {max}_{E ⊆ D} {\sum }_{e ⊆ E} s ( {f}_{θ} ( {q}_{i} ) , {f}_{θ} ( e ) ) .$$

The selected examples are appended to the input sequence (e.g., as in the prompt 256) of the large language model, along with the query 202. The input sequence is processed by the large language model using a causal attention mechanism. The attention, in one example, is limited to preceding tokens. In one example, the embedding hᵢ is extracted from the output embedding of the {EOS} token (end of sequence), which captures both semantic and contextual patterns. The text embedding is taken from the output embedding of the special token {EOS} in one example, ensuring that the generated embeddings h; are incorporating comprehensive information of all the inputs.

The adaptive response 206 module may build on the embeddings 260 generated by the module 204. The module 206 is configured to iteratively refine automated responses based on real-time feedback or other interactions, including user interactions.

For example,

$${r}_{i}^{( t )}$$

may represent a response (e.g., response 208) generated by an application 200 at iteration t for a user query qᵢ. The refinement process performed by the module 206 improves the response iteratively based on feedback

$${F}_{i}^{( t )}$$

received after each interaction. The updated response

$${r}_{i}^{( t + 1 )}$$

is generated using a refinement function g_{φ}, parameterized by φ, which takes the previous response

$${r}_{i}^{( t )} ,$$

the original query embedding hᵢ, and the feedback

$${F}_{i}^{( t )}$$

into account as follows:

$${r}_{i}^{( t + 1 )} = {g}_{ϕ} ( {r}_{i}^{( t )} , {h}_{i} , {F}_{i}^{( f )} ) .$$

In one example, the feedback

$${F}_{i}^{( t )}$$

may include explicit ratings, implicit signals (e.g., customer hesitation), or other context, including context provided by the user. The refinement function g_{φ} adjusts the response based on the feedback, thereby ensuring that the system learns and adapts continually.

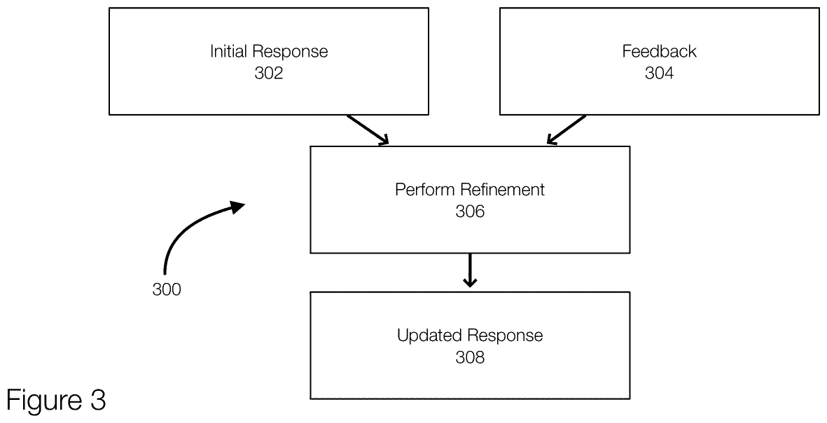

FIG. 3 discloses aspects of an adaptive response method. The method 300 includes generating 302 an initial response to a user query, which may include generating contextualized embeddings, and receiving feedback 304 (e.g., an interaction) related to the response. Refinement to the response is performed 306 by refining the response by taking into account the feedback and the original query embedding. In one example, a feedback integration mechanism dynamically weights the importance of different types of feedback.

In one example, a weighting vector w^{(t)} combines the feedback signals (e.g., different types of feedback) and updates the response accordingly by generating the feedback:

$${F}_{i}^{( t )} = {\sum }_{j = 1}^{m} {w}_{j}^{( t )} {f}_{j}^{( t )} .$$

In this example,

$${f}_{j}^{( t )}$$

represents individual feedback components and

$${w}_{j}^{( t )}$$

represents the corresponding weights. The weights may be dynamically adjusted based on relevance and reliability of each feedback component at iteration t. This allows feedback to be prioritized and ensure that the refinement 306 is effective. The updated response 308 may be generated.

In one example, the refinement function ga may be optimized during training using a loss function that penalizes deviations from a desired response quality. The loss function may be defined as follows:

$${ℒ}_{r e f} = {\sum }_{i = 1}^{n} {\sum }_{t = 1}^{T} ℓ ( {r}_{i}^{( t + 1 )} , {r}_{i}^{*} ) .$$

In this example,

$${r}_{i}^{*}$$

is an ideal response and [symbol] (⋅) is a suitable loss function (e.g., mean squared error or cross-entropy loss). The parameters of the refinement function may be updated using gradient descent methods to minimize the loss function over all iterations and queries.

The iterative refinement method 300 helps ensure that the system adapts to user interactions in real-time, thereby leading to more accurate and satisfactory responses. The continuous learning capability allows the system to handle a wide range of scenarios.

Returning to FIG. 1A, the architecture module 108 is an example of a module configured to facilitate integration and deployment of the application 100 into various platforms. The architecture module 108 may adjust the deployment in terms of scalability, efficiency, and adaptability.

In one example, a pipeline integration or deployment mechanism is employed. When the application is integrated into a platform, incoming queries are processed by the module 104 (or 204), followed by the module 106 (or 206). Refined responses generated by the module 106 may be handled by an interaction management module 110, which may handle communications with a user.

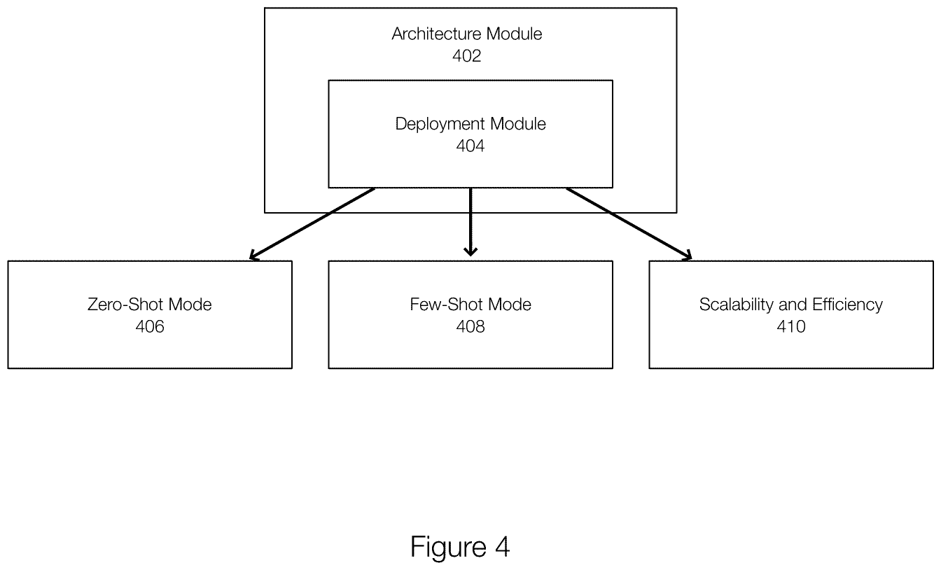

FIG. 4 discloses aspects of a an architecture module. The architecture module 402 (or 108), may include a deployment module 404 that may allow an application to be configured or deployed in various modes. In a zero-shot mode 406, the system being deployed may generate responses based on pre-trained models without any task-specific examples. In a few-shot mode 408, the system may use a number of historical examples provided, in one example, at runtime, to generate more accurate and contextually relevant responses.

More specifically in one example, in zero-shot mode 406, the system leverages pre-trained embeddings and the response generation models handle queries for which no prior examples are available. The absence of task-specific training data is compensated by the generalization capabilities of LLMs, which generates responses based on their broad trainings. In the few-shot mode 208, the system dynamically selects a small set of task-specific examples from a database and uses these examples to fine-tune the embeddings and responses that are generated. This allows the system to handle specialized queries that require contextual understanding, thereby improving the relevance and accuracy of responses.

The architecture module 402 also ensures or promotes scalability and efficiency 410. The system (e.g., system 100) can be deployed on cloud platforms, in distributed computing systems to manage high traffic. The modular nature of the system 100 allows for incremental updates and improvements without requiring an overhaul of the deployment module 404.

Embodiments of the invention thus relate to systems and methods for enhancing applications such as customer support applications by contextually enriching embeddings by integrating few-shot learning into the text embedding process, which includes dynamically selecting relevant historical analysis based on a real-time query analysis in one example.

Embodiments of the invention further include adaptive response refinement where the system iteratively improves generated responses using contextually enriched embeddings, with a refinement layer that adjusts responses based on interactions, including feedback, and interaction history.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, context generation operations, response refinement operations, historical sample selection operations, few-shot training operations, response generation operations, customer service operations, query response operations, chatbot operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software.

Example embodiments are applicable to any system capable of storing and handling various types of objects or data, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a query from a user at an application, generating contextualized embeddings based on the query and historical examples, generating a response based on the contextualized embeddings, refining the response based on an earlier response, feedback, and the contextualized embeddings to generate a refined response, and presenting the refined response to the user.

Embodiment 2. The method of embodiment 1, further comprising selecting the historical examples from a dataset of examples.

Embodiment 3. The method of embodiment 1 and/or 2, wherein the historical examples selected from the dataset of examples maximize a contextual alignment with the query.

Embodiment 4. The method of embodiment 1, 2, and/or 3, further comprising determining one or more feedback, the feedback including interactions with the user.

Embodiment 5. The method of embodiment 1, 2, 3, and/or 4, wherein the one or more feedback include explicit ratings, implicit signals, or context provided by the user.

Embodiment 6. The method of embodiment 1, 2, 3, 4, and/or 5, further comprising dynamically weighting the one or more feedback based on reliability of each of the one or more feedback.

Embodiment 7. The method of embodiment 1, 2, 3, 4, 5, and/or 6, wherein the response is refined iteratively.

Embodiment 8. The method of embodiment 1, 2, 3, 4, 5, 6, and/or 7, wherein the historical examples are included with the query as few-shot learning, wherein the historical examples and the query are input to a model that generates the contextual embeddings.

Embodiment 9. The method of embodiment 1, 2, 3, 4, 5, 6, 7, and/or 8, further comprising deploying the application in a first mode or a second mode, wherein the first mode is a zero-shot mode and the second mode is a few-shot mode.

Embodiment 10. The method of embodiment 1, 2, 3, 4, 5, 6, 7, 8, and/or 9, further comprising generating a ticket for the contextual embeddings.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments or edge environment where one or more of a client, server, or other machine may reside and operate in a cloud environment or edge environment.

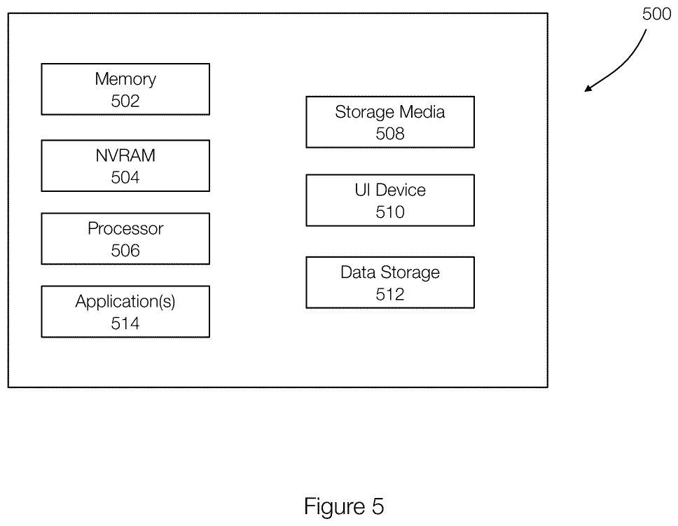

With reference briefly now to FIG. 5, any one or more of the entities disclosed, or implied, by Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
receiving a query from a user at an application;
generating contextualized embeddings based on the query and historical examples;
generating a response based on the contextualized embeddings;
refining the response based on an earlier response, feedback, and the contextualized embeddings to generate a refined response; and
presenting the refined response to the user.

2. The method of claim 1, further comprising selecting the historical examples from a dataset of examples.

3. The method of claim 2, wherein the historical examples selected from the dataset of examples maximize a contextual alignment with the query.

4. The method of claim 1, further comprising determining one or more feedback, the feedback including interactions with the user.

5. The method of claim 4, wherein the one or more feedback include explicit ratings, implicit signals, or context provided by the user.

6. The method of claim 5, further comprising dynamically weighting the one or more feedback based on reliability of each of the one or more feedback.

7. The method of claim 1, wherein the response is refined iteratively.

8. The method of claim 1, wherein the historical examples are included with the query as few-shot learning, wherein the historical examples and the query are input to a model that generates the contextual embeddings.

9. The method of claim 1, further comprising deploying the application in a first mode or a second mode, wherein the first mode is a zero-shot mode and the second mode is a few-shot mode.

10. The method of claim 1, further comprising generating a ticket for the contextual embeddings.

11. A non-transitory storage medium having stored therein instructions that are executable by one or more hardware processors to perform operations comprising:
receiving a query from a user at an application;
generating contextualized embeddings based on the query and historical examples;
generating a response based on the contextualized embeddings;
refining the response based on an earlier response, feedback, and the contextualized embeddings to generate a refined response; and
presenting the refined response to the user.

12. The non-transitory storage medium of claim 11, further comprising selecting the historical examples from a dataset of examples.

13. The non-transitory storage medium of claim 12, wherein the historical examples selected from the dataset of examples maximize a contextual alignment with the query.

14. The non-transitory storage medium of claim 11, further comprising determining one or more feedback, the feedback including interactions with the user.

15. The non-transitory storage medium of claim 14, wherein the one or more feedback include explicit ratings, implicit signals, or context provided by the user.

16. The non-transitory storage medium of claim 15, further comprising dynamically weighting the one or more feedback based on reliability of each of the one or more feedback.

17. The non-transitory storage medium of claim 11, wherein the response is refined iteratively.

18. The non-transitory storage medium of claim 11, wherein the historical examples are included with the query as few-shot learning, wherein the historical examples and the query are input to a model that generates the contextual embeddings.

19. The non-transitory storage medium of claim 11, further comprising deploying the application in a first mode or a second mode, wherein the first mode is a zero-shot mode and the second mode is a few-shot mode.

20. The non-transitory storage medium of claim 11, further comprising generating a ticket for the contextual embeddings.
